(19) United States
(12) Patent Application Publication
(10) Pub. No.: US 2018/0194621 A1
(43) Pub. Date: Jul. 12, 2018

(54) POROUS NANO STRUCTURE USEFUL AS ENERGY STORAGE MATERIAL, AND METHOD OF MANUFACTURING SAME

(71) Applicant: KOREA ADVANCED INSTITUTE OF SCIENCE AND TECHNOLOGY, Daejeon (KR)

(72) Inventors: Il-Kwon OH, Daejeon (KR); Jung-Hwan OH, Daejeon (KR); Jung-Hwan JUNG, Daejeon (KR); Hyun-Jun KIM, Daejeon (KR)

(21) Appl. No.: 15/741,501

(22) PCT Filed: Dec. 7, 2015
(86) PCT No.: PCT/KR2015/013327

§ 371 Date: Jan. 2, 2018

(30) Foreign Application Priority Data
Sep. 18, 2015 (KR) 10-2015-0132487

(51) Int. Cl. C01B 3/00; B01J 20/20; B01J 20/06; B01J 20/28; B01J 20/30; B01J 19/12

(52) U.S. Cl. CPC C01B 3/0078; C01B 3/0031; B01J 20/20; B01J 20/06; B01J 20/2808; B01J 20/28083; B01J 2219/089; B01J 20/28061; B01J 20/28064; B01J 20/3085; B01J 19/126; B01J 2219/1206; B01J 20/28085

(57) ABSTRACT

The present invention relates to a porous nano structure and a method of manufacturing same. The porous nano structure exhibits excellent mechanical strength and has a wide specific surface area and is therefore useful as an absorbent, a vibration absorber, a sound absorber, a shock absorber, a catalyst support, a membrane for separation, etc., and can be applied to various technical fields such as electronics, composite materials, sensors, catalysts, energy storage materials, and ultra-high capacity storage batteries. In particular, the porous nano structure exhibits excellent hydrogen storage capability and is thus very useful as a hydrogen storage material.

### TECHNICAL FIELD

The present invention relates to a porous nanostructure useful as an energy storage material and a preparation method thereof.

### BACKGROUND ART

Porous carbon materials can be utilized as catalyst supports, impurity adsorbents, membranes for separation, etc., and have been studied in a variety of fields such as electronics, complex materials, sensors, catalysts, energy-related electrodes, and ultra high capacity batteries. Of them, graphene has received much attention, because of its excellent electrical conductivity and stable structure. However, graphene still has many limitations in applications, such as the difficulty of assembling in a three-dimensional form due to high resistance at the interface and the stacking problem of graphene.

### DISCLOSURE

### Technical Problem

The present invention provides a porous nanostructure and a preparation method thereof. Further, the present invention provides an energy storage material including the porous nanostructure.

### Technical Solution

According to an embodiment of the present invention, provided is a porous nanostructure including a graphene layer which has a plurality of graphenes stacked and has pores formed on the surface or inside thereof; and metal particles embedded in the graphene layer.

The graphene layer may be composed of a graphene having no functional groups, a graphene oxide, a reduced graphene oxide, or a mixture thereof. The pores formed in the graphene layer may have an average diameter of 0.01 nm to 100 nm.

A maximum particle size of the embedded metal particles may be 100 nm or less.

Meanwhile, the porous nanostructure may further include metal particles on the surface of the graphene layer. A particle size of the metal particles present on the surface of the graphene layer may be smaller than the particle size of the embedded metal particles.

The metal particles may be Pd, Pt, Ni, or a mixture thereof.

The porous nanostructure may have a specific surface area of 350 m²/g to 750 m²/g.

Meanwhile, according to another embodiment of the present invention, provided is a method of preparing the porous nanostructure, the method including the step of dispersing a metal compound in a graphene, and then irradiating microwaves thereto.

Specifically, the step of irradiating microwaves may include irradiating microwaves twice or more times. More specifically, the step of irradiating microwaves may include irradiating the metal compound-dispersed graphene with microwaves at 500 W to 900 W for 5 seconds to 1 minute, with microwaves at 500 W to 900 W for 30 seconds to 2 minutes, and then with microwaves at 700 W to 1100 W for 30 seconds to 2 minutes.

Meanwhile, according to still another embodiment of the present invention, provided is an energy storage material including the porous nanostructure.

### Effect of the Invention

According to an embodiment of the present invention, provided is a porous nanostructure having excellent mechanical strength and a wide specific surface area. Due to these characteristics, the porous nanostructure may be useful as an adsorbent, a vibration-absorbing material, a sound-absorbing material, a shock-absorbing material, a catalyst support, a membrane for separation, etc., and therefore, may be applied to a variety of fields such as electronics, complex materials, sensors, catalysts, energy storage materials, and ultra high capacity batteries. In particular, the porous nanostructure is very useful as a hydrogen storage material due to its excellent hydrogen storage capacity.

### BRIEF DESCRIPTION OF DRAWINGS

FIG. 1 is an FESEM image of a porous nanostructure prepared according to Example 1;

FIG. 2 is a TEM image of the porous nanostructure prepared according to Example 1;

FIG. 3 is a graph showing a specific surface area of the porous nanostructure prepared according to Example 1; and

FIG. 4 is a graph showing hydrogen storage capacity according to a pressure of the porous nanostructure prepared according to Example 1.

### DETAILED DESCRIPTION OF THE EMBODIMENTS

Hereinafter, a porous nanostructure, a preparation method thereof, and an energy storage material using the porous nanostructure according to specific embodiments of the present invention will be described.

According to an embodiment of the present invention, provided is a porous nanostructure including a graphene layer which has a plurality of graphenes stacked and has pores formed on the surface or inside thereof; and metal particles embedded in the graphene layer.

Atomic scale defects in known graphene-based materials have been considered as factors detrimental to intrinsic physical properties such as mechanical strength or electrochemical properties. However, the present inventors found that deliberately introduced defects may impart new characteristics to graphene-based materials, thereby completing the present invention.

Specifically, the porous nanostructure according to an embodiment of the present invention includes a graphene layer having a plurality of graphenes stacked, in which numerous pores are formed on the surface or inside of the graphene layer. The numerous pores are deliberately introduced defects which may impart new properties, specifically, very excellent energy storage capacity, and more specifically, very excellent hydrogen storage capacity.

The graphenes constituting the graphene layer may include functional groups; or no functional groups; or part of the graphenes may include functional groups and part of them may not. Of them, at least some of the graphene layers may be composed of graphenes including functional groups, in terms of achieving superior energy storage capacity of the porous nanostructure. Therefore, the porous nanostructure may be formed from readily available graphene oxides. As a result, the graphene layer may include a layer composed of a graphene oxide or a reduced graphene oxide formed by reduction of the graphene oxide during the preparation process of the porous nanostructure. Also, the graphene layer may include all of the graphene having no functional groups, the graphene oxide, and the reduced graphene oxide. Further, the number of the graphene layers is not particularly limited, and several to several tens of graphene layers may exist. Also, the porous nanostructure may be mixed with a single-layer graphene which may be produced during the preparation process of the porous nanostructure.

Since the numerous pores are formed on the surface or inside of the graphene layer, the porous nanostructure may include the graphene layer of a three-dimensional structure. The pores may be formed by embedded metal particles described below, and their shape is not particularly limited, but the pores may have a hole or channel shape. An average diameter of the pore may be about 0.01 nm to 100 nm. Within this range, the porous nanostructure may have excellent mechanical strength and a wide specific surface area, and in particular, it may exhibit excellent energy storage capacity.

The metal particles are embedded in the graphene layer. In particular, the metal particles may be embedded in the pores of the graphene layer. The metal particles embedded in the graphene layer may be formed in an appropriate size by controlling a microwave irradiation power and an irradiation time according to a preparation method described below. As the microwave irradiation power is stronger and the irradiation time is longer, a larger number of the metal particles aggregate, and therefore, metal particles having a larger particle size may be formed. A maximum diameter of the embedded metal particles may be 100 nm or less. Within this range, the metal particles may be stably embedded in the pores of the graphene layer, thereby achieving excellent energy storage capacity. The diameters of the embedded metal particles may vary depending on the preparation conditions, and it is difficult to determine the size uniformly. Accordingly, a lower limit of the maximum diameter of the metal particles is not particularly limited. When the maximum diameter of the embedded metal particles is more than 0 nm and 100 nm or less, the above-described effect may be achieved.

Meanwhile, the graphene layer may further include metal particles on the surface thereof, in addition to the metal particles embedded in the pores. Specifically, the metal particles present on the surface of the graphene layer may be metal particles that do not aggregate and are not embedded and thus remain on the surface of graphene, when the porous nanostructure is prepared according to the preparation method described below. The metal particles present on the surface interact or bind with functional groups on the surface of the graphene layer, and like the embedded metal particles, they separate hydrogen molecules into hydrogen atoms, when they meets hydrogen molecules, and function to move the hydrogen atoms to the surface, thereby further improving hydrogen storage capacity.

The metal particles present on the surface of the graphene layer may have a size smaller than that of the metal particles embedded in the pores.

The metal particles included in the porous nanostructure may be appropriately selected depending on purpose of use of the porous nanostructure. For example, when the porous nanostructure is utilized as an energy storage material, the metal particles may be Pd, Pt, Ni or a mixture thereof in terms of achieving excellent energy storage capacity.

As described above, the porous nanostructure may have a very wide specific surface area, owing to the pores formed on the surface and inside of the graphene layer having a plurality of graphenes stacked and the metal particles embedded in the graphene layer. More specifically, the porous nanostructure may have a specific surface area of 350 m²/g to 750 m²/g, indicating that these values are very wide values, as compared with a specific surface area of a graphene of 331.2 m²/g.

Since the porous nanostructure may have excellent mechanical properties and a wide specific surface area, it may be applied to a variety of fields, such as an adsorbent, a vibration-absorbing material, a sound-absorbing material, a shock-absorbing material, a catalyst support, etc. Further, the porous nanostructure is useful as an energy storage material. In particular, the porous nanostructure has very excellent hydrogen storage capacity, and therefore, it is expected that the porous nanostructure is very useful as a hydrogen storage material.

Meanwhile, according to another embodiment of the present invention, provided is a method of preparing the porous nanostructure. More specifically, the method of preparing the porous nanostructure may include the step of dispersing a metal compound in a graphene, and then irradiating microwaves thereto. According to another embodiment of the present invention, a porous nanostructure including metal particles embedded in a three-dimensional graphene layer may be prepared by a simple method of the microwave irradiation.

Specifically, in the step of irradiating microwaves, the metal compound is first dispersed in the graphene.

As described above, a graphene having functional groups or no functional groups may be used as the graphene, or a mixture of the graphene having functional groups and the graphene having no functional groups may be also used. Of them, graphene oxide may be used as the graphene, in terms of achieving excellent energy storage capacity.

A compound including metal particles to be added to the porous nanostructure may be used as the metal compound. For example, when Pd particles are intended to be used as the metal particles, palladium acetate, etc. may be used as the metal compound.

In order to more uniformly disperse the metal compound in the graphene, a dispersion solvent may be used. A type of the dispersion solvent is not particularly limited, and a solvent having an affinity for the graphene and the metal compound and having a low boiling point and volatility to be easily removed may be used. For non-limiting example, alcohol, such as ethanol, etc. may be used as the dispersion solvent.

The graphene and the metal compound are stirred in the presence of the dispersion solvent, and then dried to obtain metal compound-dispersed graphene in the form of a powder.

After dispersing the metal compound in the graphene, microwaves may be irradiated thereto. The microwave irradiation may be performed once or more times, and in order to form the desired size and degree of defects in the graphene, the microwave irradiation may be performed twice or more times. In this regard, the metal particles may be aggregated and the pore may be formed in a suitable size and number by controlling a microwave irradiation power and an irradiation time.

Specifically, the metal compound-dispersed graphene may be irradiated with microwaves of 500 W to 900 W for 5 seconds to 1 minute (step a), microwaves of 500 W to 900 W for 30 seconds to 2 minutes (step b), and then microwaves of 700 W to 1100 W for 30 seconds to 2 minutes (step c).

In step a, when high-power microwaves are irradiated for a short time, the metal compounds dispersed in the graphene are degraded and metal particles having a small particle size may be decorated on the graphene. In this regard, when the graphene includes functional groups such as graphene oxide, the metal particles having a small particle size may exist in a state of interacting or binding with the functional groups. Further, as in step b, when high-power microwaves are irradiated for a longer time, the metal particles having a small particle size in the graphene may aggregate to form metal particles having a larger particle size. Subsequently, as in step c, when higher-power microwaves are irradiated for an appropriate time, the aggregated metal particles having a larger particle size may generate pores in the graphene layer, and may be embedded in some of the pores. Also in step b, some of the aggregated metal particles having a larger particle size may generate pores in the graphene layer, and may be embedded in some of the pores. Also in step c, the metal particles having a small particle size or the aggregated metal particles having a larger particle size may also further aggregate to form metal particles having a much larger particle size.

As such, according to another embodiment of the present invention, a porous nanostructure having a desired structure may be easily prepared by the simple method such as microwave irradiation.

Meanwhile, according to still another embodiment of the present invention, provided is an energy storage material including the porous nanostructure. The porous nanostructure may be very useful as an energy storage material, in particular, as a hydrogen storage material. The porous nanostructure itself has high hydrogen adsorption ability, and hydrogen inside the porous nanostructure may be moved to the surface through the metal particles included in the porous nanostructure, thereby showing more excellent hydrogen storage capacity.

Hereinafter, actions and effects of the present invention will be described in more detail with reference to specific Examples of the present invention. However, these are for illustrative purposes only, and the scope of the present invention is not intended to be limited thereby.

### EXAMPLE 1

### Synthesis of Porous Nanostructure

High-purity graphite oxide was synthesized by a Modified Hummer's Method. In detail, 2 g of high-purity graphite and 2 g of sodium nitrate (NaNO₃) were added to 100 mL of sulfuric acid (H₂SO₄), and the resulting mixture was allowed to react under stirring for 30 minutes. Then, a reaction vessel containing the mixture was transferred to an ice bath, and then 12 g of potassium permanganate (KMnO₄) was slowly added to the reaction vessel. Then, while the temperature of the mixture was raised to room temperature by separating the ice bath from the reaction vessel, the mixture was stirred. After completing the reaction, 560 mL of deionized water and 40 mL of hydrogen peroxide (H₂O₂) were serially added to the reaction vessel, and the mixture was centrifuged, filtered, and then dried in a vacuum oven to obtain a powdery graphite oxide.

The graphite oxide was irradiated with microwaves of 700 W for several seconds to obtain exfoliated graphene oxide from graphite oxide.

To graphene oxide thus obtained, ethanol and a small amount of palladium acetate were added, and the mixture was sonicated to prepare a dispersion solution. This dispersion solution was dried in an oven at 60° C. to obtain a powdery palladium acetate-dispersed graphene oxide. The palladium acetate-dispersed graphene oxide was irradiated with microwaves of 700 W within 30 seconds to synthesize graphene oxide, of which the surface was decorated with Pd particles having a small particle size (Pd nanoparticle-decorated graphene oxide (Pd-D-G)). Subsequently, the Pd-D-G was irradiated with microwaves of 700 W within 60 seconds and then with microwaves of 900 W within 60 seconds. As a result, Pd particles having a small particle size aggregated with each other on the surface of the graphene oxide to form Pd clusters which were dispersed into several graphene oxide layers, and nanoholes were formed in the outer layer. Through this process, a porous nanostructure having Pd particles embedded in graphene oxide was synthesized.

### EXPERIMENTAL EXAMPLE

### Evaluation of Characteristics of Porous Nanostructure

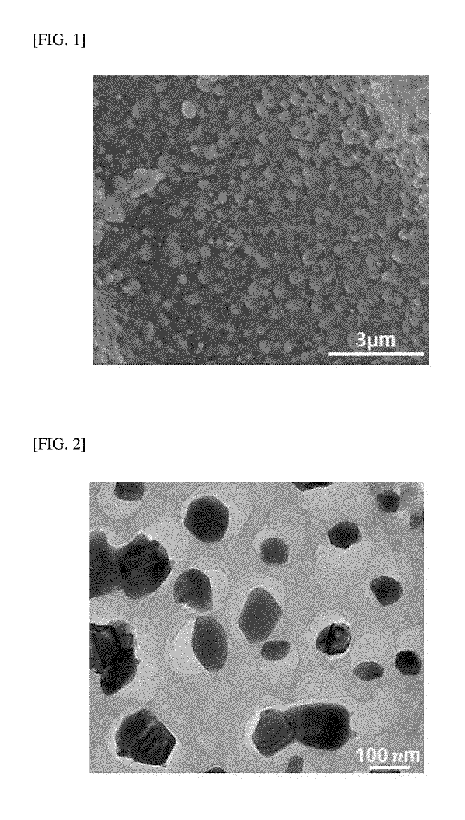

(1) Identification of structure of porous nanostructure by electron microscopy FESEM (Field Emission Scanning Electron Microscope) analysis was performed using a Nova NanoSEM 230 FEI at 2 kV in a gentle-beam mode, after the porous nanostructure prepared according to Example 1 was coated with no metal, and completely dried, and then placed on a carbon tape. An FESEM of the porous nanostructure is shown in FIG. 1.

Meanwhile, TEM (Transmission Electron Microscopy) analysis was performed using a holey carbon film on 300 mesh copper grids by a Tecnai G2 F20 microscope operated at 300 kV. A TEM analysis sample was prepared by drying the porous nanostructure prepared according to Example 1 and then by dispersing part of the dried porous nanostructure in ethanol. When the prepared sample was dropped on the copper grids, ethanol may be evaporated in the air at room temperature. A TEM image of the porous nanostructure thus confirmed is shown in FIG. 2.

Referring to FIGS. 1 and 2, it was confirmed that numerous pores were formed in the graphene layer, and Pd particles were embedded in the pores.

(2) Evaluation of Specific Surface Area

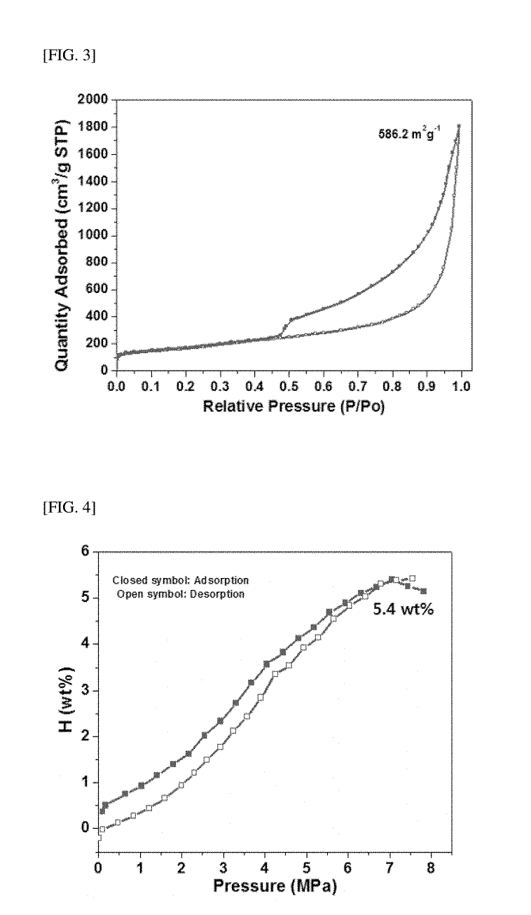

A BET (Brunauer-Emmett-Teller) specific surface area of the porous nanostructure prepared according to Example 1 was obtained from nitrogen adsorption and desorption isotherms at 77 K. The nitrogen adsorption and desorption isotherms are shown in FIG. 3.

Referring to FIG. 3, the porous nanostructure prepared according to Example 1 was found to have a specific surface area of 586.2 m²/g.

(3) Evaluation of Hydrogen Storage Capacity

Hydrogen storage capacity was measured by a computer-controlled commercial Pressure-Composition Temperature (PCT) method using a high pressure volumetric apparatus (Belsorp-HP (BEL Japan, Inc.), and this apparatus was calibrated with LaNi₅ (1.46 wt %) at 313 K, and with activated carbon (max. 4.86 wt %) at 77 K. Hydrogen storage capacity according to a pressure of the porous nanostructure prepared according to Example 1 is shown in FIG. 4.

Referring to FIG. 4, the porous nanostructure according to an embodiment of the present invention was found to have high hydrogen storage capacity of about 5.4% by weight.

This study was supported by Korean Energy Technology Evaluation and Planning (KETEP) granted financial resource from the Ministry of Commerce, Industry and Energy in 2015 (No. 20128510010050).

1. A porous nanostructure comprising a graphene layer which has a plurality of graphenes stacked, and has pores formed on the surface or inside thereof; and metal particles embedded in the graphene layer.

2. The porous nanostructure of claim 1, wherein the graphene layer is composed of a graphene having no functional groups, a graphene oxide, a reduced graphene oxide, or a mixture thereof.

3. The porous nanostructure of claim 1, wherein an average diameter of the pores is 0.01 nm to 100 nm.

4. The porous nanostructure of claim 1, wherein a maximum particle size of the embedded metal particles is 100 nm or less.

5. The porous nanostructure of claim 1, further comprising metal particles on the surface of the graphene layer.

6. The porous nanostructure of claim 5, wherein a particle size of the metal particles on the surface of the graphene layer is smaller than the particle size of the embedded metal particles.

7. The porous nanostructure of claim 1, wherein the metal particles are Pd, Pt, Ni, or a mixture thereof.

8. The porous nanostructure of claim 1, wherein the porous nanostructure has a specific surface area of 350 m²/g to 750 m²/g.

9. A method of preparing the porous nanostructure of claim 1, the method comprising the step of dispersing a metal compound in a graphene, and then irradiating microwaves thereto once or more times.

10. The method of claim 9, wherein the step of irradiating microwaves comprises irradiating microwaves twice or more times.

11. The method of claim 10, wherein the step of irradiating microwaves comprises irradiating the metal compound-dispersed graphene with microwaves at 500 W to 900 W for 5 seconds to 1 minute, with microwaves at 500 W to 900 W for 30 seconds to 2 minutes, and then with microwaves at 700 W to 1100 W for 30 seconds to 2 minutes.

12. An energy storage material comprising the porous nanostructure of claim 1.
